(19) United States
(12) Patent Application Publication
(10) Pub. No.: US 2008/0079572 A1
(43) Pub. Date: Apr. 3, 2008

(54) Apparatus and method for using a wireless network as a motion detection system

(76) Inventors: Zohar Tsaba, Kiryat Tivon (IL); Shmuel Levy, Kiryat Tivon (IL)

Correspondence Address: INTEL CORPORATION;c/o INTELLEVATE, LLC, P.O. BOX 52050, MINNEAPOLIS, MN, 55402, US

(21) Appl. No.: 11/540,988

(22) Filed: Sep. 28, 2006

(51) Int. Cl. G08B 13/18

(52) U.S. Cl. 340/552

(57) ABSTRACT

Embodiments of an apparatus and methods, for monitoring an environment using a wireless network and sending a signal if movement is detected, are generally described herein. Other embodiments may be described and claimed.

### FIELD OF THE INVENTION

The field of invention relates generally to the field of security systems and, more specifically but not exclusively, relates to the use of wireless network communication signals for the detection and notification of movement within a physical environment in the range of the wireless network.

### BACKGROUND INFORMATION

Security systems are typically characterized according to their design architecture as either wired or wireless detection and alarm systems. Both wired and wireless detection and alarm systems normally require the user to purchase and install additional equipment to perform the tasks of detection and alarm, which can be substantial whether the system of choice is a wired or a wireless system. The method of detection is sometimes performed using a passive infrared detection system, which is based on differences in temperature in the environment. Infrared sensors in a detection unit sample the ambient room temperature and detect an intruder's body heat moving across its detection zones. If an intruder enters the environment, the detection unit can, depending its design, send either a wired or a wireless radio frequency (RF) to a master alarm unit to signal a siren or to initiate an auto dialer.

The addition of a wired detection system can be especially costly to install and maintain because, in addition to the added equipment, an installation in a home or a building may require substantial additions and changes to the existing wiring system. In a wired detection system that is designed to detect an opening of a door or window, an alarm in which interruption of electric current to a relay, caused, for example, by the breaking of a metallic tape, de-energizes a relay and causes the relay contacts to operate an alarm indicator. When an alarm condition is detected, the alarm system may sound the alarm throughout the house with one or more sirens or the alarm system may initiate an auto dialer to send a message to an outside monitoring entity. Each siren and auto dialer requires a separate installation and is usually wired in, even in so-called wireless systems.

The addition of a wireless detection and alarm system usually requires a hardwired keypad, a base station, a hardwired siren, AC power connections, and an auto dialer connection to a telephone line, if the system is designed to send a message to an outside monitoring entity. Such wireless systems also require, therefore, considerable wiring, which also makes them expensive to install due to the costs of the equipment, expert installation and related maintenance.

### BRIEF DESCRIPTION OF THE DRAWINGS

The present invention is illustrated by way of example and not as a limitation in the figures of the accompanying drawings, in which

FIG. 1 is an illustration of a wireless communications apparatus for monitoring movement in an environment in the range of the wireless network.

FIG. 2 illustrates Station A in FIG. 1 in communication with an access point and the internet gateway.

FIG. 3 is a flowchart of a method for monitoring movement in a physical environment in the range of the wireless network.

FIG. 4 is an embodiment of a process of the method in FIG. 3 for monitoring movement in a physical region in the range of the wireless network.

### DETAILED DESCRIPTION

An apparatus and method of using wireless network communication signals for the detection of movement within a physical environment in the range of the wireless network is disclosed in various embodiments. However, one skilled in the relevant art will recognize that the various embodiments may be practiced without one or more of the specific details, or with other replacement and/or additional methods, materials, or components. In other instances, well-known structures, materials, or operations are not shown or described in detail to avoid obscuring aspects of various embodiments of the invention. Similarly, for purposes of explanation, specific numbers, materials, and configurations are set forth in order to provide a thorough understanding of the invention. Nevertheless, the invention may be practiced without specific details. Furthermore, it is understood that the various embodiments shown in the figures are illustrative representations and are not necessarily drawn to scale.

Reference throughout this specification to “one embodiment” or “an embodiment” means that a particular feature, structure, material, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention. Furthermore, the particular features, structures, materials, or characteristics may be combined in any suitable manner in one or more embodiments. Various additional layers and/or structures may be included and/or described features may be omitted in other embodiments.

Various operations will be described as multiple discrete operations in turn, in a manner that is most helpful in understanding the invention. However, the order of description should not be construed as to imply that these operations are necessarily order dependent. In particular, these operations need not be performed in the order of presentation. Operations described may be performed in a different order than the described embodiment. Various additional operations may be performed and/or described operations may be omitted in additional embodiments.

There is a general need for a method of detecting movement and sending notification of the movement in a physical region without having to purchase and install additional motion detection and alarm equipment. In one embodiment, one may use a wireless networking apparatus to determine baseline conditions corresponding to a wireless communications link within a physical region. The wireless networking apparatus may monitor subsequent conditions corresponding to the wireless communications link to determine a difference profile for a comparison between the baseline conditions and the subsequent conditions. The wireless networking apparatus may transmit a command signal if the difference profile corresponds to a securing breach condition in the physical region.

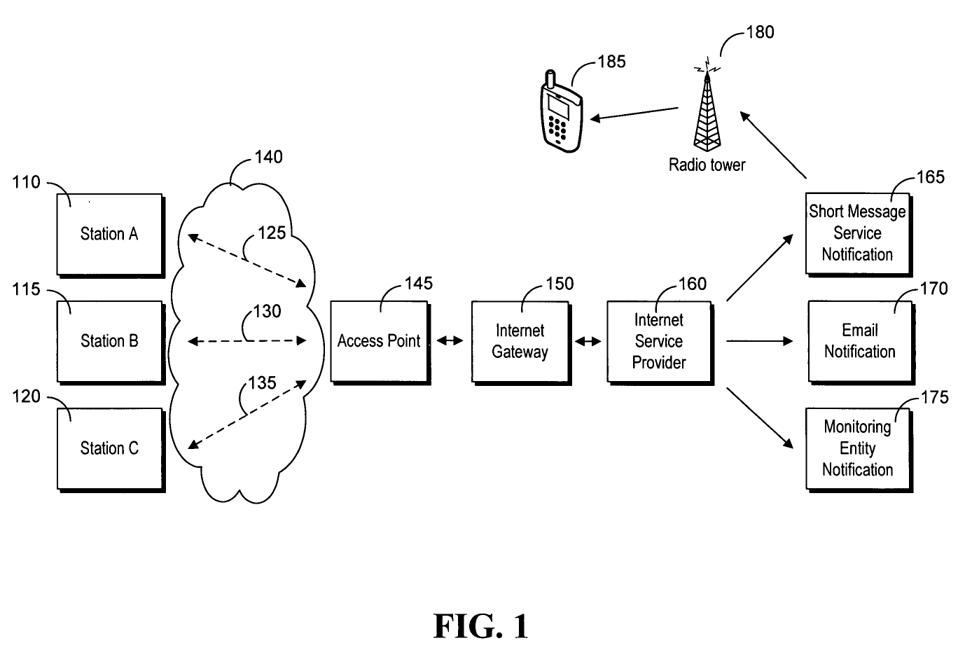

Turning now to the figures, the illustration in FIG. 1 is an exemplary embodiment of a wireless communications apparatus, or station, for monitoring movement in a physical region in the range of the wireless network. In this embodiment, three stations functioning as nodes in a wireless network are in wireless communication with an access point and monitoring for movement in a physical region. However, any number of stations may be supported. Station A 110 is monitoring for movement over a wireless communications link 125 in a physical region 140. Similarly, station B 115 and station C 120 are monitoring for movement over wireless communications links 130 and 135 respectively in physical region 140.

In some embodiments, station A 110, station B 115 and/or station C 120, hereinafter “the stations”, may be part of a desktop computer or television or a portable wireless communication device such as a laptop or portable computer with wireless communication capability, a personal digital assistant (PDA), a web tablet, a wireless telephone, a wireless headset, a pager, an instant messaging device, a digital camera, or other device that may receive and transmit information over a wireless network. For example, station A 110 may be a laptop monitoring for movement over wireless communication link 125 in a physical region 140 such as a home, in an office, in a building, or over an open field, though the embodiment is not so limited. The stations may be isolated from one another, or they may be in communication with one another through a wired or a wireless connection.

The wireless communication link 125 may be in accordance with specific communication standards, such as the Institute of Electrical and Electronics Engineers (IEEE) standards including IEEE 802.11(a), 802.11(b), 802.11(g), and/or 802.11(n) standards and/or proposed specifications for wireless local area networks, although the scope of the invention is not limited in this respect as they may also be suitable to transmit and/or receive communications in accordance with other techniques and standards. For more information with respect to the IEEE 802.11, please refer to “IEEE Standards for Information Technology—Telecommunications and Information Exchange Between Systems”—Local Area Networks—Specific Requirements—Part 11 “Wireless LAN Medium Access Control (MAC) and Physical Layer (PHY), ISO/IEC 8802-11: 1999” and related amendments/versions.

Station A 110 may be in communication over wireless communication link 125 with access point 145. An access point in a wireless network system is used for various purposes or functions including: (1) providing connection between the stations and the wireless network; (2) performing the point control functions for the associated stations, as defined by a standardized protocol such as the IEEE 802.11 standard; and (3) providing the connectivity between the wireless network and the wired network (e.g., an Ethernet network). The access point 145 communicates to the internet through an internet gateway 150 such as a cable modem, a digital subscriber line (DSL) modem, or a similar device that allows high-speed access to information at a distant server, which may be an Internet server, via a cable system, a satellite connection, or a normal telephone network. The internet gateway 150 connects to the internet through an internet service provider (ISP) 160, which is sometimes referred to as an internet access provider (IAP). The ISP 160 may be a company that provides individuals and other companies access to the Internet and other web related services.

In one embodiment, station A 110 is used to sense movement in the physical region 140 and send a command signal to initiate a notification such as a short message service (SMS) notification 165, an email notification 170, and/or a monitoring entity notification 175, though the embodiment is not so limited. An SMS notification 165 or an email notification 170 may be sent to a digital mobile phone and other mobile devices, e.g. a personal digital assistant (PDA), Pocket PC, a Blackberry®, a pager, or a laptop computer, in the form of an appropriate short text message or email to notify a user about an event, such as a physical movement in the physical region 140.

In one embodiment, an SMS notification 165 is sent by a radio tower 180 to a mobile device 185 to notify a user of a movement in the physical region 140. For example, if the mobile device 185 comprises a cellular phone, an RF interface would include radio hardware to support cellular-based communications using an appropriate cellular standard. In other embodiments, other wireless communication standards may be employed, such as but not limited to communications defined by the Institute of Electrical Institute of Electrical and Electronic Engineers (IEEE) 802.11, Wireless Fidelity (Wi-Fi) and IEEE 802.16 Worldwide Interoperability for Microwave Access (WiMAX) suites of standards. Alternatively or in combination with the SMS notification 165 or email notification 170, station A 110 may send a monitoring entity notification 175 to a security monitoring company, to alert them of an event in the physical region 140.

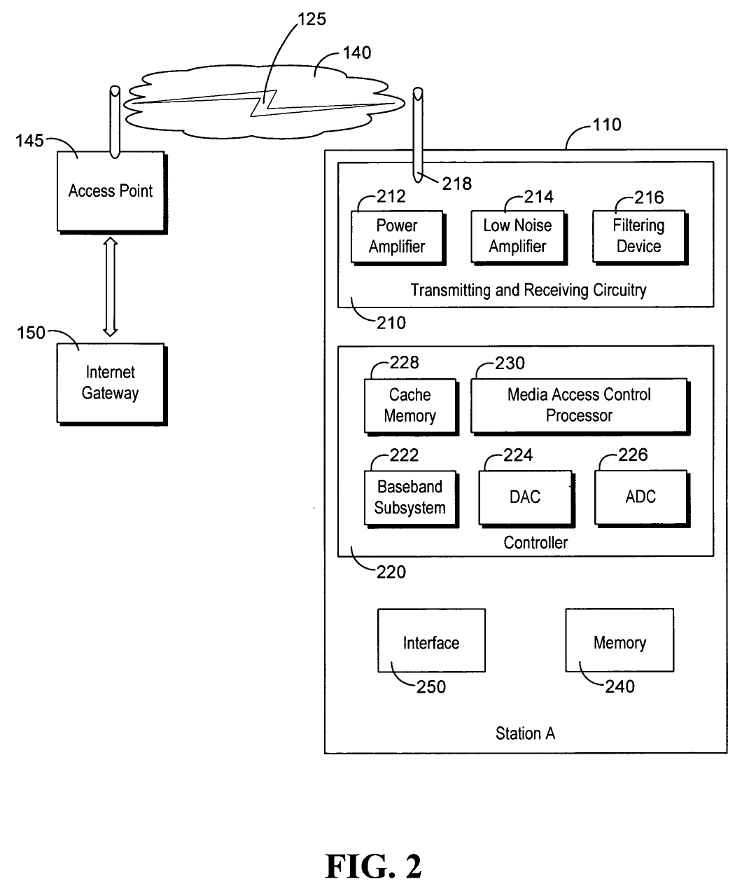

The illustration in FIG. 2 graphically describes station A 110 of FIG. 1, though any station may be used for the example, in communication through wireless communications link 125 in a physical region 140, with an internet gateway 150 using an access point 145. Station A 110 may comprise a transmitting and receiving circuitry 210 including a power amplifier 212, a low noise amplifier 214, a filtering device 216, and an antennae 218. The transmitting and receiving circuitry 210 may operate at a frequency range between 2.4 and 2.5 gigahertz (GHz) and/or at a frequency range between 4.9 and 5.95 GHz.

One function of the transmitting and receiving circuitry 210 is to provide the ability to transmit a request for and receive baseline conditions and subsequent conditions over the wireless communications link 125. Baseline conditions are parameters used to characterize the wireless communication link 125 in the absence of an event, such as the movement of an intruder in the physical region 140. Subsequent conditions are parameters used to characterize the wireless communications link 125 after the baseline conditions have been established. A difference profile may be determined based on a difference between the subsequent conditions and the baseline conditions. The difference profile is compared to a security breach condition, which is a pre-determined condition set to trigger a command signal to alert a user of a movement in the physical region 140. If a movement is detected by the station A 110, then a command signal will be sent over a wireless connection such as the communications link 125 or a wired connection such as a modem or auto dialer through an interface 250.

In one embodiment, the baseline conditions and subsequent conditions are radio frequency (RF) energy signals received by station A 110 at a desired energy level. For example, the conditions may be in the form of received signal strength indicator (RSSI) signals. The RSSI signals are a measurement of the received radio signal strength, in the form of a generic radio receiver technology metric. The conditions may also be in the form of a packet error rate (PER). A PER is the ratio, in percent, of a number of test packets not successfully received by the access point to the number of test packets sent to the access point by a test set. Further, the conditions may be in the form of a signal to noise ratio (SNR). Signal to noise ration is an expression for the power ratio between a signal and a background noise received by the station.

The station A 110 may also include a controller 220 containing a media access control processor 230, a cache memory 228, a baseband subsystem 222, a digital to analog controller 224, and an analog to digital controller 226, though the embodiment is not so limited. The controller may be used to convert the baseline conditions to baseline data and the subsequent conditions to subsequent data. The controller may also be used to store baseline data, subsequent data, and data concerning a security breach condition. An additional memory 240 device may be connected to the controller 220 to provide additional storage space for data. The additional memory 240 may be volatile or non-volatile memory in the form of read only memory (ROM); a random access memory (RAM); a magnetic disk storage media; an optical storage media; or a flash memory device, etc.

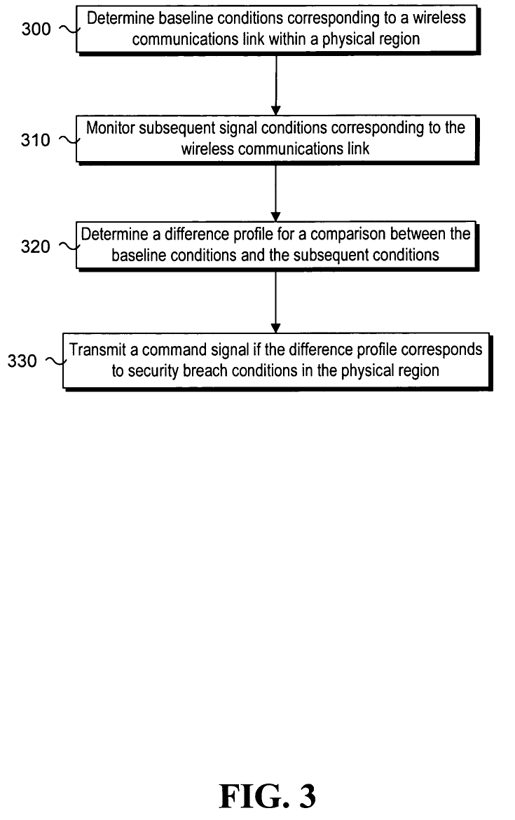

FIG. 3 is a flowchart of a method for monitoring movement in a physical region in the range of the wireless network as illustrated in FIGS. 1 and 2. The method may be initiated (element 300) by determining baseline conditions corresponding to a wireless communication link 125, such as a wireless local area network, within a physical region 140. Baseline conditions are parameters used to characterize the wireless communication link 125 in the absence of an event, such as the movement of an intruder in the physical region 140. Subsequent conditions, or parameters such as channel information based on preambles, RSSI, PER, and/or SNR, are monitored (element 310). A difference profile is determined (element 320) to form a comparison between the baseline conditions and the subsequent conditions. A command signal is transmitted, either through a wired or wireless interface 250 or through the transmitting and receiving circuitry 210, if the difference profile corresponds to a security breach condition in the physical region 140.

In one embodiment, station A 110 may receive an RSSI between −10 dB milliwatts (dBm) and −96 dBm, as typical with Cisco®. The station A 110 may determine baseline conditions by determining an average value and a standard deviation based on received RSSI values. Threshold values may be established at ±10% of the average value and the standard deviation. If one or more subsequently measured group of RSSI values, creating a difference profile, exceeds the threshold values, a command signal may be transmitted. In another embodiment, the threshold values may be established at ±20% of the average value and the standard deviation, though the embodiment is not so limited. Threshold values for channel information based on preambles, PER, and SNR may be set similarly.

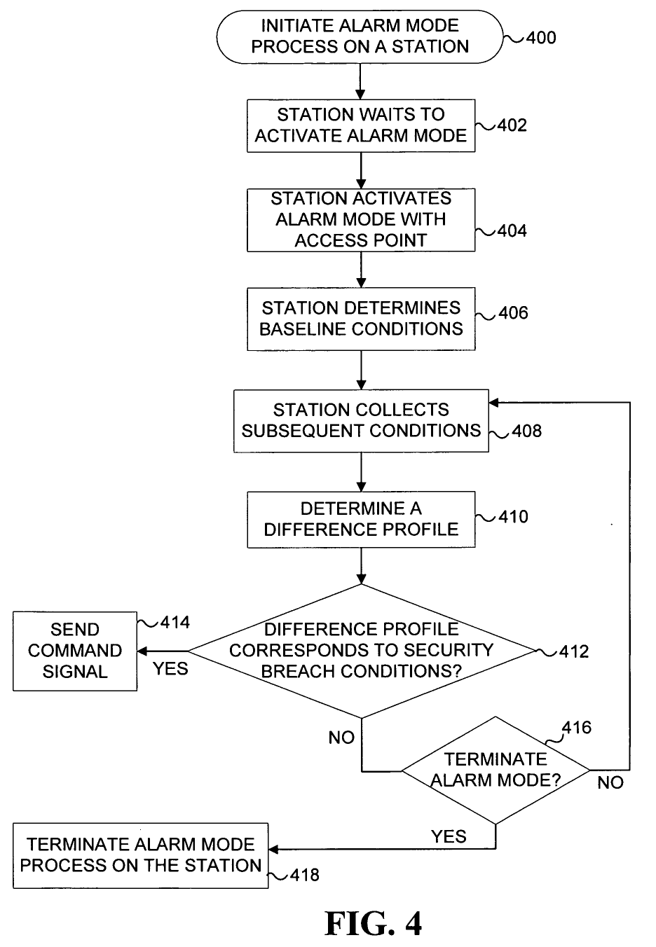

FIG. 4 is an embodiment of a process of the method in FIG. 3 for monitoring movement in a physical region 140 in the range of the wireless communications link 125, as illustrated in FIGS. 1 and 2. In this embodiment, a user initiates an alarm mode (element 400) on a station such as station A 110. The station waits a predetermined amount of time (element 402) to allow the user to move outside of a physical region 140. The station activates the alarm mode with an access point 145 (element 404) using a communication link 125. The station collects baseline conditions (element 406) then collects subsequent conditions (element 408). A difference profile is determined (element 410) and the difference profile is compared against a security breach condition (element 412). If the difference profile meets the security breach condition, then a command signal is sent (element 414). Otherwise, the system will continue collecting subsequent conditions (element 416) unless the alarm mode is terminated (element 418).

A plurality of embodiments of the use of wireless network communication signals for the detection and notification of movement within a physical region in the range of the wireless communication link have been described. The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. In the description and claims, the terms “coupled” and “connected,” along with their derivatives, may have been used. It should be understood that these terms are not intended as synonyms for each other. Rather, in particular embodiments, “connected” may be used to indicate that two or more elements are in direct physical or electrical contact with each other while “coupled” may further mean that two or more elements are not in direct contact with each other, but yet still co-operate or interact with each other.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Thus, embodiments of this invention may be used as or to support a software program executed upon some form of processing core (such as a processor of a computer) or otherwise implemented or realized upon or within a machine-readable medium. A machine-readable medium includes any mechanism for storing information in a form readable by a machine (e.g., a computer). For example, a machine-readable medium can include such as a read only memory (ROM); a random access memory (RAM); a magnetic disk storage media; an optical storage media; and a flash memory device, etc.

Modifications may be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method comprising:
determining baseline conditions corresponding to a wireless communications link within a physical region;
monitoring subsequent conditions corresponding to the wireless communications link;
determining a difference profile for a comparison between the baseline conditions and the subsequent conditions; and
transmitting a command signal if the difference profile corresponds to a security breach condition in the physical region.

2. The method of claim 1, wherein the wireless communications link is a wireless local area network.

3. The method of claim 1, wherein the conditions are radio frequency energy signals received at an energy level.

4. The method of claim 3, further including specifying the energy level of the conditions when transmitting a request for baseline conditions over the wireless communications link.

5. The method of claim 1, wherein the conditions are received signal strength indicator signals.

6. The method of claim 1, further including periodically measuring a background noise signal.

7. The method of claim 6, further including forming ratios of the conditions by the background noise signal.

8. The method of claim 1, wherein the conditions are packet error rate data.

9. The method of claim 1, wherein transmitting the command signal over the wireless communication link.

10. The method of claim 1, wherein transmitting the command signal through an interface to a modem or an autodialer.

11. The method of claim 1, wherein the command signal is sent in response to a movement by an intruder in the physical region.

12. A wireless communications apparatus comprising:
transmitting circuitry to transmit a request for baseline conditions over a wireless communications link;
receiving circuitry to receive baseline conditions and subsequent conditions over the wireless communications link;
a controller to convert the baseline conditions to baseline data and the subsequent conditions to subsequent data;
a memory to store the baseline data and a security breach condition; and
the controller to determine a difference profile between the baseline data and the subsequent conditions and to generate a command signal if the difference profile corresponds to a security breach condition.

13. The wireless communications apparatus of claim 12, wherein the transmitting circuitry and the receiving circuitry comprise an antenna, a power amplifier, a low noise amplifier, and a filtering device.

14. The wireless communications apparatus of claim 12, wherein the controller comprises a cache memory, a baseband subsystem, a media access control processor, an analog to digital controller and a digital to analog controller.

15. The wireless communications apparatus of claim 12, wherein the memory is a separate volatile or non-volatile memory device.

16. The wireless communications apparatus of claim 12, further including an interface to send a command signal through a modem or an autodialer.

17. The wireless communications apparatus of claim 12, wherein the transmitting and receiving circuitry is used to send a command signal.

18. A machine-accessible medium that provides instructions, which when accessed, cause a machine to perform operations comprising:
determining baseline conditions corresponding to a wireless communications link within a physical region;
monitoring subsequent conditions corresponding to the wireless communications link;
determining a difference profile for a comparison between the baseline conditions and the subsequent conditions; and
transmitting a command signal if the difference profile corresponds to a securing breach condition in the physical region.

19. The machine-accessible medium of claim 18, wherein the wireless communications link is a wireless local area network.

20. The machine-accessible medium of claim 18, further including specifying the energy level of the conditions when transmitting a request for baseline conditions over the wireless communications link.
